(19) United States
(12) Patent Application Publication
(10) Pub. No.: US 2023/0027292 A1
(43) Pub. Date: Jan. 26, 2023

(54) AMORPHOUS FLUORINATED COPOLYMERS AND METHODS OF MAKING AND USING THE SAME

(71) Applicant: Chromis Fiberoptics, Inc., Warren, NJ (US)

(72) Inventors: Christopher P. Junk, Wilmington, DE (US); Whitney Ryan White, Watchung, NJ (US)

(21) Appl. No.: 17/757,213

(22) PCT Filed: Dec. 11, 2020
(86) PCT No.: PCT/US2020/064553

§ 371 Date: Jun. 10, 2022

Related U.S. Application Data
(60) Provisional application No. 62/964,855, filed on Jan. 23, 2020.
(60) Provisional application No. 62/948,037, filed on Dec. 13, 2019.

(51) Int. Cl. C08F 216/14; C08J 5/18; C08F 216/12; C10L 3/10; B01D 71/32; B01D 53/22

(52) U.S. Cl. CPC C08F 216/1416; C08J 5/18; C08F 216/1408; C08F 216/125; C10L 3/103; C10L 3/104; B01D 71/32; B01D 53/228; C08J 2347/00; C10L 2290/548

(57) ABSTRACT

Described herein are amorphous fluorinated copolymers produced by the polymerization of one or more fluorinated ring monomers and one or more fluorinated comonomers containing multiple ether oxygens. The copolymers are suitable in many high-technology applications, such as optical fibers, anti-reflection coatings, protective coatings, and gas separation membranes. In one aspect, the copolymers are useful is in the field of membrane-based gas separation processes. In one aspect, amorphous copolymer is produced by polymerizing (a) one or more fluorinated ring monomers in the amount of 1 mol % to 99.5 mol %, wherein the fluorinated ring monomer is at least a five membered ring and (b) a comonomer in the amount of from 0.5 mol % to 99 mol %, wherein the comonomer comprises a fluorinated compound with two or more ether oxygens.

### CROSS REFERENCE TO RELATED APPLICATIONS

This application claims the benefit of U.S. Provisional Application No. 62/948,037 filed on Dec. 13, 2019 and of U.S. Provisional Application No. 62/964,855 filed on Jan. 23, 2020, both of which are incorporated herein by reference in their entireties.

### BACKGROUND

Separation of CO₂ and chemically similar gases (including H₂S and other water-soluble acid gases) from non-polar gases, including N₂, O₂, methane, and other hydrocarbons is an important industrial problem. One large-scale application for this type of separation is the decarbonization of effluent gases (“flue gases”) in power plants and other combustion devices, which is important for reduction of CO₂ emissions related to global warming. Another major application for this type of gas separation is removal of corrosive acid gases, including CO₂ and H₂S, from a natural gas stream, also known as “natural gas sweetening.”

These types of acid gas separations have historically been accomplished by a variety of methods, including chemical absorption, cryogenic distillation, and membrane separation. Chemical absorption has been extensively developed in the oil and gas industries with “amine scrubbing” technology, in which alkyl amines (such as mono-ethanolamine) form chemical complexes with acid gases, thus removing them from the gas stream [see for example, Bahadori, Natural Gas Processing: Technology and Engineering Design, Elsevier, Amsterdam, 2014]. Cryogenic distillation operates on the principle that CO₂ has a much higher freezing point than most other combustion effluents (principally nitrogen), so it may be frozen out as a liquid or a solid, leaving the other gases to pass through the system [see for example, Xu, et. al “An Improved CO₂ Separation and Purification System Based on Cryogenic Separation and Distillation Theory” Energies 2014, 7, 3484-3502]. Although both chemical absorption and cryogenic distillation are effective methods of capturing CO₂, they typically require significant energy input and considerable capital equipment. In the case of alkylamine absorption processes, the amines are typically corrosive and toxic liquids. Also, since these amines have limited functional lifetimes, they must be regularly replaced and properly disposed of. This represents a significant burden in remote operating locations, such as offshore platforms. Consequently, simpler, more energy efficient, and longer-lasting separation methods are desired.

Membrane-based gas separation methods operate on the principle of differential permeability of gases through the selective layer of a membrane, which is often composed of polymers. The membrane material in such a separation process is chosen to provide a very high permeability for one or more of the gases, while providing a much lower permeability for the other gases. The mixed gas stream is then introduced on one side of the membrane, and the high permeability gases pass preferentially through the membrane, resulting in a “permeate” gas stream on the other side of the membrane. This permeate stream will be enriched in the high-permeability gases compared with the input gas stream. Meanwhile as the input stream proceeds across the input-side surface of the membrane to the exit of the membrane module, it will become enriched in low-permeability species compared with the input gas stream. This stream is referred to as the “retentate” stream [see for example, Baker, Membrane Technology and Applications, Wiley, West Sussex, 2012].

Because this membrane-based separation requires only a pressure differential across the membrane to operate, it can be accomplished with relatively simple and reliable equipment, typically consisting primarily of a compressor and a membrane module. For the same reason, it typically uses far less power than the above methods of gas separation. Moreover, membrane based methods of gas separation avoid the use of toxic and corrosive materials such as alkyl amines often used in chemical absorption methods, and they typically offer a considerably lower capital cost as well.

The membranes most commonly used in gas separations are hydrocarbon polymers, including cellulose acetate and polyimides for separation of acid gases from methane [see for example, Xuezhong He in Encyclopedia of Membranes, Springer-Verlag, Berlin Heidelberg 2015]. While these hydrocarbon membranes typically display a relatively high selectivity under ideal conditions, their performance is degraded considerably in certain applications by absorbed gases, which can chemically degrade the polymer and/or cause plasticization of the polymer membranes. In the case of natural gas sweetening applications, CO₂ is known to plasticize cellulose acetate and polyimide membranes, resulting in reduced CO₂ permeability and reduced CO₂/CH₄ selectivity [Ibid]. This problem typically becomes more acute at elevated pressure and CO₂ content.

### SUMMARY

Described herein are amorphous fluorinated copolymers produced by the polymerization of one or more fluorinated ring monomers and one or more fluorinated comonomers containing multiple ether oxygens. The copolymers are suitable in many high-technology applications, such as optical fibers, anti-reflection coatings, protective coatings, and gas separation membranes. In one aspect, the copolymers are useful is in the field of membrane-based gas separation processes.

In one aspect, amorphous copolymer is produced by polymerizing (a) one or more fluorinated ring monomers in the amount of 1 mol % to 99.5 mol %, wherein the fluorinated ring monomer is at least a five membered ring and (b) a comonomer in the amount of from 0.5 mol % to 99.5 mol %, wherein the comonomer comprises a fluorinated compound with two or more ether oxygens.

In another aspect, the amorphous copolymer comprises (a) a plurality of fluorinated ring units in the amount of 1 mol % to 99.5 mol %, wherein the fluorinated ring unit is at least a five membered ring and (b) a comonomeric unit in the amount of from 0.5 mol % to 99 mol %, wherein the comonomeric unit is fluorinated and has two or more ether oxygens.

In another aspect, described herein is a method for separating a first gaseous component from a gaseous mixture said process comprising passing the gaseous mixture across a separation membrane comprising an amorphous copolymer as described herein.

In another aspect, described herein are articles comprising an amorphous copolymer as described herein such as, for example, a multi-layer structured article, a film, membrane, tube, or fiber.

Other methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### DETAILED DESCRIPTION

Many modifications and other embodiments disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### Definitions

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, the terms “optional” or “optionally” means that the subsequently described event or circumstance can or cannot occur, and that the description includes instances where said event or circumstance occurs and instances where it does not.

As used in the specification and the appended claims, the singular forms “a,” “an” and “the” include plural referents unless the context clearly dictates otherwise. Thus, for example, reference to “a fluorinated ring monomer,” “a comonomer,” or “a copolymer,” include, but are not limited to, mixtures or combinations of two or more such fluorinated ring monomers, comonomers, or copolymers, and the like.

The term “gas” as used herein means a gas or a vapor.

The term “polymer” as used herein generally includes, but is not limited to, homopolymers, copolymers, such as for example, block, graft, random and alternating copolymers, terpolymers, etc. and blends and modifications thereof. Furthermore, unless otherwise specifically limited, the term “polymer” shall include all possible geometrical configurations of the material. These configurations include, but are not limited to, isotactic and atactic symmetries.

The term “highly fluorinated” as used herein means that at least 90% of the available hydrogen bonded to carbon have been replaced by fluorine.

The terms “fully-fluorinated” and “perfluorinated” as used herein are interchangeable and refer to a compound where all of the available hydrogens bonded to carbon have been replaced by fluorines.

The term “alkenyl” or “olefinic” as used herein is a fluorocarbon group of from 2 to 24 carbon atoms with a structural formula containing at least one carbon-carbon double bond. Asymmetric structures such as (A¹A²)C═C(A³A⁴) are intended to include both the E and Z isomers. This can be presumed in structural formulae herein wherein an asymmetric alkene or olefin is present, or it can be explicitly indicated by the bond symbol C═C. In one aspect, an “alkenyl” or “olefinic” compound can include two carbon-carbon double bonds (e.g., is a diene).

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

All percentages herein are by volume unless otherwise stated. Unless otherwise specified, temperatures referred to herein are based on atmospheric pressure (i.e. one atmosphere).

### Amorphous Copolymers and Methods for Making the Same

In one aspect, the disclosed amorphous copolymers are produced by polymerizing fluorinated ring monomers and comonomers having multiple ether oxygens. Described below are the components and methods for making the copolymers.

### Fluorinated Ring Monomers

In one aspect, the fluorinated ring monomer includes a five-membered ring. In another aspect, the fluorinated ring monomer includes a six-membered ring. In still another aspect, the fluorinated ring monomer contains a five-membered ring and a six-membered ring, or includes two five-membered rings. Further in this aspect, when the fluorinated ring monomer contains two rings, the rings can be fused to form a bicyclic structure. In another aspect, the fluorinated ring monomer can be perfluorinated.

In another aspect, the fluorinated ring monomer can have an olefinic structure, where the monomer possesses one or more carbon-carbon double bonds. In another aspect, the fluorinated ring monomer can be a conjugated or non-conjugated diene. In one aspect, representative fluorinated ring monomers include, but are not limited to, to one or more olefinic compounds shown in Scheme 1 and Scheme 2 below as well as combinations thereof

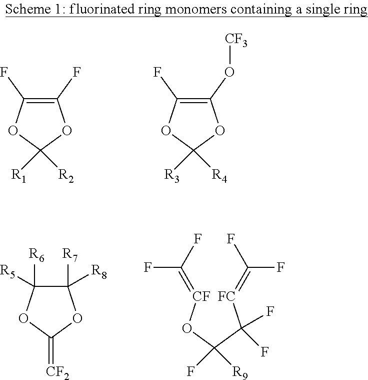

in which:
R₁ and R₂ are independently F, CF₃, CF₂CF₃, CF₂H, CF₂CF₂H, CFHCF₃, CFHCF₂H;
R₃ and R₄ are independently F, CF₃, or CF₂CF₃, CF₂H, CF₂CF₂H, CFHCF₃, CFHCF₂H;
R₅, R₆, R₇, and R₈ are independently F, CF₃, or CF₂CF₃, CF₂H, CF₂CF₂H, CFHCF₃, CFHCF₂H and R₆ and R₇ can be contained within a 5- or 6-membered ring; and
R₉ is F, CF₃, or CF₂CF₃

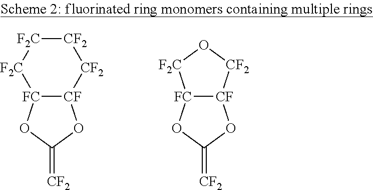

In another aspect, the fluorinated ring monomer can include one or more acyclic monomers that, upon polymerization, produce a fluorinated ring including. For example, the fourth structure depicted in Scheme 1 can cyclize upon polymerization to produce a five-membered ring.

In one aspect, the fluorinated ring monomer can be a single compound in Schemes 1 or 2. In another aspect, the fluorinated ring monomer can be two or more different compounds in Schemes 1 or 2.

In another aspect, disclosed herein is an amorphous copolymer produced by polymerizing (a) one or more fluorinated ring monomers in the amount of from about 1 mol % to about 99.5 mol %, wherein the fluorinated ring monomer is at least a five-membered ring and (b) a comonomer in the amount of from about 0.5 mol % to about 99 mol %. In one aspect, the amount of fluorinated ring monomer used to produce the copolymers described herein is 1, 5, 10, 15, 20, 25, 30, 35, 40, 45, 50, 55, 60, 65, 70, 75, 80, 85, 90, 95, or about 99.5 mol %, or a combination of any of the foregoing values, or a range encompassing any of the foregoing values. In one aspect, the amount of fluorinated ring monomer used to produce the copolymers described herein is from about 80 mol % to about 99 mol %.

### Comonomers

The comonomer is a fluorinated compound with two or more ether oxygens. In one aspect, the comonomer can be perfluorinated. In one aspect, the comonomer is an olefinic compound having two or more ether oxygens. In another aspect, the comonomer is an olefinic compound having two or more perfluoro ether groups (—CF₂—O—CF₂—).

In one aspect, the comonomer includes one or more compounds having the following structure:

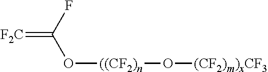

where n and m are independently 1, 2, or 3, and x is 1 or 2.

In a further aspect, the comonomer can be a single compound, or can be two or more different compounds having the structure above.

In another aspect, representative comonomers useful herein include, but are not limited to, those shown in Scheme 3 below, and any combination thereof:

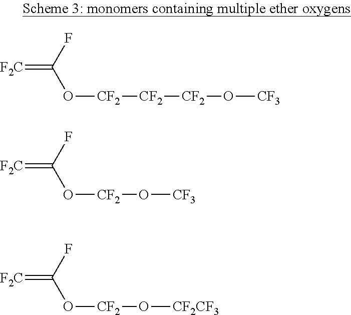

In one aspect, the amount of comonomer used to produce the copolymers described herein can be from about 0.5, 1, 5, 10, 15, 20, 25, 30, 35, 40, 45, 50, 55, 60, 65, 70, 75, 80, 85, 90, 95, or about 99.5 mol %, or a combination of any of the foregoing values, or a range encompassing any of the foregoing values. In a further aspect, the amount of comonomer is from about 1 mol % to about 20 mol %.

### Polymerization Method

In one aspect, the copolymers described herein can be made by solution or aqueous emulsion polymerization. In another aspect, if the solution method is used, suitable solvents can be poly- or perfluorinated compounds such as perfluorooctane, hexafluoroisopropanol (HFIP), 1,1,1,3,3,3-hexafluoro-2-methoxypropane (HFMOP), Vertrel® XF (CF₃CFHCFHCF₂CF₃), or Fluorinert® FC-43 (perfluorotri-n-butyl amine). In an alternative aspect, if the aqueous emulsion method is used, a suitable surfactant will be used. In one aspect, the disclosed polymers can optionally be polymerized in the absence of any solvent. In a further aspect, initiators can be chosen from those typically used for fluoropolymers such as hydrocarbon peroxides, fluorocarbon peroxides, hydrocarbon peroxydicarbonates, and inorganic types such as persulfates.

In one aspect, depending on the relative reactivity of the monomers to be used in the polymerization, they can either be added as a single precharge, or they may need to be co-fed as a ratioed mixture to produce the desired copolymer composition.

In another aspect, when the polymerization is determined to be complete, the polymer can be isolated using methods known in the art. In one aspect, for the solution method, the solvent (and any unreacted monomer(s)) can be removed by distillation at atmospheric or lower pressure. In some aspects, due to the typically high viscosity and amorphous nature of the polymers of this disclosure, further rigorous drying is often required to get rid of residual solvent. In a further aspect, this can involve heating to between 200 to 300° C. at atmospheric or lower pressure for between 2 to 48 hours. In another aspect, tor the aqueous emulsion method, the emulsion can be broken by several methods including freeze/thaw, addition of a strong mineral acid such as nitric acid, high shear mixing, or a combination of these methods.

The Examples provide non-limiting procedures for producing the copolymers described herein.

### Structure of the Amorphous Copolymers

The copolymers described herein include a plurality of fluorinated ring units and plurality of fluorinated comonomeric units having two or more ether oxygens. In one aspect, the amorphous copolymers including (a) a plurality of fluorinated ring units in the amount of from about 1 mol % to about 99.5 mol %, wherein the fluorinated ring units include a ring with at least five members and (b) a comonomeric unit in the amount of from about 0.5 mol % to about 99 mol %, wherein the comonomeric unit is fluorinated and has two or more ether oxygens. In another aspect, the fluorinated ring units can be present in an amount of about 1, 5, 10, 15, 20, 25, 30, 35, 40, 45, 50, 55, 60, 65, 70, 75, 80, 85, 90, 95, or about 99.5 mol %, or a combination of any of the foregoing values, or a range encompassing any of the foregoing values. In one aspect, the fluorinated ring unit is present in the amount of from about 80 mol % to about 99 mol %. In another aspect, the comonomeric unit can be present in an amount of about 0.5, 1, 5, 10, 15, 20, 25, 30, 35, 40, 45, 50, 55, 60, 65, 70, 75, 80, 85, 90, 95, or about 99 mol %, or a combination of any of the foregoing values, or a range encompassing any of the foregoing values. In one aspect, the comonomeric unit is present in the amount of from about 1 mol % to about 20 mol %.

### Fluorinated Ring Unit

In some aspects, the fluorinated ring unit can be perfluorinated. In another aspect, the fluorinated ring unit can include a five- or six-membered ring. In one aspect, the fluorinated ring unit can include one or more of the following structures:

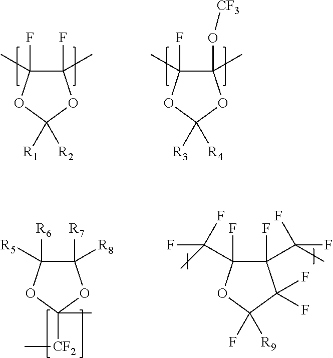

wherein:
R₁ and R₂ are independently F, CF₃, CF₂CF₃, CF₂H, CF₂CF₂H, CFHCF₃, CFHCF₂H;
R₃ and R₄ are independently F, CF₃, or CF₂CF₃, CF₂H, CF₂CF₂H, CFHCF₃, CFHCF₂H;
R₅, R₆, R₇, and R₈ are independently F, CF₃, or CF₂CF₃, CF₂H, CF₂CF₂H, CFHCF₃, CFHCF₂H and R₆ and R₇ can be contained within a 5- or 6-membered ring; and
R₉ is F, CF₃, or CF₂CF₃.

In another aspect, the fluorinated ring unit can be a single structural unit. In an alternative aspect, the fluorinated ring unit can be two or more different structural units. In one aspect, the fluorinated ring unit can be

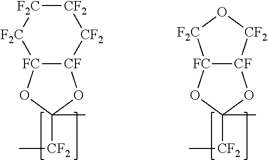

or any combination thereof.

### Comonomeric Unit

In another aspect, the comonomeric unit can be perfluorinated. In one aspect, the comonomeric unit includes one or more units having the following structure:

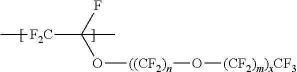

where n and m are independently 1, 2, or 3, and x is 1 or 2.

In one aspect, the comonomeric unit can be a single structural unit. In another aspect, the comonomeric unit can be two or more different structural units. In another aspect, the comonomeric unit can be:

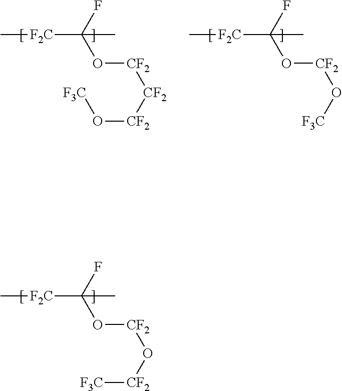

or any combination thereof.

### Copolymer Properties and Composition

In one aspect, the composition of these copolymers can usually be determined by ¹⁹F NMR spectroscopy. Further in this aspect, the polymers are readily soluble in perfluorobenzene and an insert probe of deuterobenzene (C₆D₆) can be used to give a lock signal. In a further aspect, differential scanning calorimetry (DSC) can be used to determine the glass transition temperature (T_{g}), and the molecular weight distribution can be found by using gel permeation chromatography (GPC) with a styrene-divinyl benzene column in a perfluorinated solvent coupled with a multi-detector analysis module including refractive index, low-angle light scattering, and right-angle light scattering detectors or using other suitable equipment and/or methods as known in the art. If desired, in one aspect, the type and concentration of end groups can also be determined by pressing a film of the polymer and acquiring an infrared (IR) spectrum in transmission mode.

In another aspect, the copolymer can have a glass transition temperature of from about 0° C. to about 300° C., or about 25° C., 50° C., 75° C., 100° C., 125° C., 150° C., 175° C., 200° C., 225° C., 250° C., 275° C., or 300° C., or a combination of any of the foregoing values, or a range encompassing any of the foregoing values.

In still another aspect, the copolymer can have a number average molecular weight (Mₙ) of from about 10 kDa to about 2,000 kDa, or 10 kDa, 50 kDa, 100 kDa, 150 kDa, 200 kDa, 250 kDa, 300 kDa, 350 kDa, 400 kDa, 450 kDa, 500 kDa, 550 kDa, 600 kDa, 650 kDa, 700 kDa, 750 kDa, 800 kDa, 850 kDa, 900 kDa, 950 kDa, 1,000 kDa, 1,050 kDa, 1,100 kDa, 1,150 kDa, 1,200 kDa, 1,250 kDa, 1,300 kDa, 1,350 kDa, 1,400 kDa, 1,450 kDa, 1,500 kDa, 1550 kDa, 1,600 kDa, 1,650 kDa, 1,700 kDa, 1,750 kDa, 1,800 kDa, 1,850 kDa, 1,900 kDa, 1,950 kDa, or 2,000 kDa, or a combination of any of the foregoing values, or a range encompassing any of the foregoing values.

In still another aspect, the copolymer can have a weight average molecular weight (M_{w}) of from about 10,000 g/mol to about 3,000,000 g/mol, or 10,000 g/mol, 50,000 g/mol, 100,000 g/mol, 200,000 g/mol, 300,000 g/mol, 400,000 g/mol, 500,000 g/mol, 600,000 g/mol, 700,000 g/mol, 800,000 g/mol, 900,000 g/mol, 1,000,000 g/mol, 1,100,000 g/mol, 1,200,000 g/mol, 1,300,000 g/mol, 1,400,000 g/mol, 1,500,000 g/mol, 1,600,000 g/mol, 1,700,000 g/mol, 1,800,000 g/mol, 1,900,000 g/mol, 2,000,000 g/mol, 2,100,000 g/mol, 2,200,000 g/mol, 2,300,000 g/mol, 2,400,000 g/mol, 2,500,000 g/mol, 2,600,000 g/mol, 2,700,000 g/mol, 2,800,000 g/mol, 2,900,000 g/mol, or 3,000,000 g/mol, or a combination of any of the foregoing values, or a range encompassing any of the foregoing values.

### Articles Including the Copolymers

Disclosed herein is an article including or made from the disclosed copolymers. In one aspect, the article can be a multi-layered structured article, wherein at least one layer of the structure includes or is made from the disclosed copolymers. In another aspect, the article can be a film, a membrane, a tube, or a fiber.

In still another aspect, the article can include a layer or coating of the copolymer. In one aspect, the layer or coating has a thickness of less than or equal to 1 μm, or less than or equal to about 950, 900, 850, 800, 750, 700, 650, 600, 550, or about 500 nm, or a combination of any of the foregoing values, or a range encompassing any of the foregoing values. In another aspect, the layer or coating has a thickness of about 50 nm, 100 nm, 150 nm, 200 nm, 250 nm, 300 nm, 350 nm, 400 nm, 450 nm, 500 nm, 550 nm, 600 nm, 650 nm, 700 nm, 750 nm, 800 nm, 850 nm, 900 nm, 950 nm, or 1 μm, or a combination of any of the foregoing values, or a range encompassing any of the foregoing values.

In a further aspect, the copolymer may be formed or shaped into any shape that is necessary or desirable for use as a membrane. There are numerous methods known to shape the copolymer chosen for the selective layer into single-layer or multi-layer films or membranes. In some aspects the selective layer can comprise an unsupported film, tube, or fiber of the polymer as a single-layer membrane. In some aspects, an unsupported film may be too thick to permit desirable gas flow through the membrane. Therefore, in some aspects, the membrane may comprise a very thin selective layer, placed on top of a much more permeable supporting structure. For example, in one aspect, the membrane may comprise an integral asymmetric membrane, in which a more dense selective layer is placed on top of a microporous support layer. Such membranes were originally developed by Loeb and Sourirajan, and their preparation in flat sheet or hollow fiber form is described, for example, in U.S. Pat. No. 3,133,132 to Loeb, and U.S. Pat. No. 4,230,463 to Henis and Tripodi, the disclosures of which are incorporated herein by reference.

In some aspects, the membrane may comprise multiple layers, including at least one selective layer, with each layer serving a distinct purpose. Further in this aspect, in such multilayer composite membranes, there may be a microporous support layer, which provides mechanical strength. In another aspect, the multilayer membrane may include a non-porous, but highly permeable “gutter” layer, for example, coated on the microporous support layer. Further in this aspect, this gutter layer is generally not selective, but may instead form a smooth surface on which to deposit the extremely thin selective layer, which performs the primary selective function of the membrane. In another aspect, the gutter layer also may channel permeate gas to the pores of the support layer. In an additional aspect, the selective layer may be covered by a protective layer. In one aspect, the primary purpose of the protective layer is to prevent fouling of the selective layer, such as by certain components of the gas stream. In some aspects, the disclosed multilayer structures may be, but not necessarily, formed by solution casting. General preparation techniques for making composite membranes of this type are described, for example, in U.S. Pat. No. 4,243,701 to Riley et al, the disclosures of which are incorporated herein by reference. In one aspect, disclosed herein is a gas separation membrane including a feed side and a permeate side, wherein the separation membrane has a selective layer that includes or is constructed from a copolymer described herein.

In an aspect, the multilayer composite membrane may take flat-sheet, tube, or hollow-fiber form. In hollow-fiber form, in one aspect, multilayer composite membranes may be made by a coating procedure as taught, for example, in U.S. Pat. Nos. 4,863,761; 5,242,636; and 5,156,888, or by using a double-capillary spinneret of the type taught in U.S. Pat. Nos. 5,141,642 and 5,318,417, the disclosures of which are incorporated herein by reference.

In another aspect, the thickness of the membrane's selective layer may be determined based on one or more parameters of the separation process. In some aspects, the thickness of the membrane's selective layer is less than about 1 μm. In a preferred embodiment, the selective layer can be even thinner, for example, the selective layer can be as thin as 0.5 μm or less. The selective layer, in one aspect, should have a thickness that is sufficiently thin so that the membrane provide a pressure-normalized hydrogen flux, as measured with pure hydrogen gas at 25° C., of at least 100 GPU (where 1 GPU=1×10⁻⁶ cm³(STP)/cm²s cmHg), and preferably at least 400 GPU.

In one aspect, the copolymer membranes described herein are mechanically ductile, and also exhibit high thermal stability, and high chemical resistance. In another aspect, the copolymers described herein that form the selective layer are typically insoluble only in perfluorinated solvents. In still another aspect, they are also typically stable over many years when immersed in acids, alkalis, oils, low-molecular-weight esters, ethers and ketones, aliphatic and aromatic hydrocarbons, and oxidizing agents. In yet another aspect, they are also thermally stable over many years at temperatures below the glass transition temperature. Thus, in any of these aspects, they are suitable for use in natural gas streams and many other demanding environments.

In one aspect, the membrane may be used in any suitable apparatus. For example, membranes are typically used in the form of a module, comprising the membrane prepared in any known form, and housed in any convenient type of housing and separation unit. Any number of membrane modules may be used in conjunction (e.g., in serial, in parallel) to treat a gas stream. The number of membrane modules may be determined based on one or more factors including, for example, the necessary or desired flow volume, stream composition, and other operating parameters of the separation process. In the separation process, in one aspect, the membrane is exposed to a flowing gaseous feed-composition comprising the gas mixture. In another aspect, this gas flow is created by a pressure differential that is established across the membrane, either through pressurization of the feed/retentate side of the membrane, or application of vacuum to the permeate side of the membrane. Separation of the components of the gas stream occurs, in one aspect, through the membrane, producing a gas stream on the permeate-side of the membrane with a composition enriched in the more permeable component of the gas mixture. Conversely, in another aspect, the gas stream exiting the module on the feed/retentate side of the membrane has a composition that is depleted in the more permeable component of the gas mixture, and thus enriched in the less permeable component (or components) of the gas mixture.

In one aspect, the disclosure relates to an apparatus and a process for separating at least one component from a gas mixture. In another aspect, the disclosed apparatus includes a membrane that includes a “selective layer” that is configured to be selectively permeable for the desired component to be separated from the gas mixture. Optionally, in an aspect, the membrane may contain one or more other layers which serve various purposes, such as a porous support layer, a “gutter layer” which allows the permeate gas to pass from the selective layer to the porous layer with minimal flow impedance, and a protective layer, which protects the selective layer from fouling.

Applications of Membranes with Amorphous Copolymers

The copolymers described herein are useful in the field of gas separation. When a membrane is used to perform gas separation, the selectivity αᵢⱼ of a material for separating different gasses (denoted by indices i and j) is a function of both the diffusivity D of each gas in the material, as well as the solubility S of that gas in the material, according to the relationship

αᵢⱼ=Pᵢ/Pⱼ=(Dᵢ*Sᵢ)/(Dᵢ*Sⱼ)

Hence, in order to optimize the functionality of a material for separation of gases i and j, it is typically desirable to select a material with a high ratio of permeability Pᵢ/Pⱼ, with the more permeable gas designated with index i. Thus, by varying the amount of fluorinated ring monomers and comonomers described herein, a membrane with a copolymer described herein can be fine-tuned to separate specific gases from gaseous mixtures.

In one aspect, disclosed herein is a method for separating a first gaseous component from a gaseous mixture, the process comprising passing the gaseous mixture across a separation membrane that includes the disclosed copolymer. In one aspect, the polymeric material used as a membrane selective layer can be selected from the class of highly fluorinated or perfluorinated amorphous copolymers. In another aspect, highly fluorinated or perfluorinated copolymers are desirable because such materials typically have excellent chemical resistance. In a further aspect, polymeric material is amorphous (or nearly amorphous), as opposed to a crystalline fluoropolymer. In some aspects, it is desirable that the membrane selective layer may be cast from solution, so the polymeric material should be soluble in one or more solvents, and therefore crystalline fluoropolymers, which typically have negligible solubility in solvents, would, in some aspects, not be preferred. In another aspect, crystalline polymers typically exhibit low gas permeabilities as compared to amorphous polymers.

In some aspects, a process for separating a first component from a gaseous mixture includes introducing a feed stream comprising the gaseous mixture to the disclosed membrane. Further in these aspects, the membrane has a first side, a second side, and a selective layer that is selectively permeable for the first component, i.e., the first component has a higher permeability through the selective layer than other components of the gaseous mixture. In one aspect, the feed stream is introduced to the first side of the membrane. Further in this aspect, a driving force (e.g., pressure differential) causes at least a portion of the gaseous mixture to permeate through the membrane from the first side to the second side, providing a permeate stream on the second side of the membrane. In a further aspect, the resulting permeate stream is enriched in the first component. In another aspect, a residue or retentate stream depleted in the first component may be withdrawn from the first side of the membrane.

In one aspect, in the gas separation method disclosed herein, the method includes at least the following steps:
(a) passing the gaseous mixture across a separation membrane having a feed side and a permeate side, the separation membrane having a selective layer that is selectively permeable to at least the first gaseous component, wherein the gaseous layer includes the copolymer; and
(b) providing a driving force sufficient for transmembrane permeation of at least a portion of the gaseous mixture from the feed side to the permeate side of the separation membrane, resulting in a gaseous permeate stream on the permeate side of the separation membrane and a gaseous retentate stream on the feed side of the separation membrane, wherein the gaseous permeate stream includes the first gaseous component.

In another aspect, the permeate stream has a concentration of first component that is greater than a concentration of the first component in the retentate stream.

In still another aspect, the method further includes the step of withdrawing the permeate stream from the permeate side of the separation membrane. In a further aspect, the method also includes the step of withdrawing the retentate stream from the feed side of the separation membrane.

In one aspect, the first gaseous component is carbon dioxide, hydrogen sulfide, helium, or any combination thereof. In one aspect, the gaseous mixture includes methane and carbon dioxide.

In another aspect, more than about 50, 55, 60, 65, 70, 76, 80, 86, 90, or more than about 95% of the first gaseous component in the gaseous mixture permeates through the separation membrane, or a combination of any of the foregoing values, or a range encompassing any of the foregoing values.

In one aspect, the copolymers will be useful in a number of applications, particularly those related to separation of CO₂ from other gases. In one aspect, the disclosed copolymers including fluorinated comonomers containing multiple ether oxygens show even greater enhancement of the solubility of CO₂ in amorphous fluoropolymers, and hence improve the selectivity of these materials with regard to certain separations of CO₂ gas.

In one aspect, the copolymers described herein have a CO₂ solubility that is at least 10% higher than the comparable polymer produced with fluorinated ring monomers. In another aspect, the copolymers described herein have a selectivity for CO₂/CH₄ separations that is at least 10% higher than the comparable polymer produced only the fluorinated ring monomers.

In one aspect, the membrane and process disclosed here are useful for separating acid gases, including carbon dioxide and hydrogen sulfide, from a natural gas stream, which might be found either at a well or a processing plant. In another aspect, since such natural gas streams often contain higher molecular weight hydrocarbon vapors that can foul or plasticize hydrocarbon membranes, the perfluorinated nature of the selective layer in the present disclosure is particularly suitable for such applications, as it is highly resistant to such degradation.

In addition to undesirable acid gases, in one aspect, natural gas streams sometimes contain helium, which is desirable as a separate product. In a further aspect, the process of the present disclosure is useful for separating helium from natural as streams, so that the resulting helium-rich gas can be further refined into purified helium.

### Aspects

Aspect 1. An amorphous copolymer produced by polymerizing (a) one or more fluorinated ring monomers in the amount of 1 mol % to 99.5 mol %, wherein the fluorinated ring monomer is at least a five membered ring and (b) a comonomer in the amount of from 0.5 mol % to 99 mol %, wherein the comonomer comprises a fluorinated compound with two or more ether oxygens.

Aspect 2. The copolymer of aspect 1, wherein the fluorinated ring monomer is perfluorinated.

Aspect 3. The copolymer of aspects 1 or 2, wherein the fluorinated ring monomer is an olefinic compound.

Aspect 4. The copolymer of aspects 1-3, wherein the fluorinated ring monomer comprises a five or six membered ring.

Aspect 5. The copolymer of aspect 1, wherein the fluorinated ring monomer comprises one or more of the following compounds:

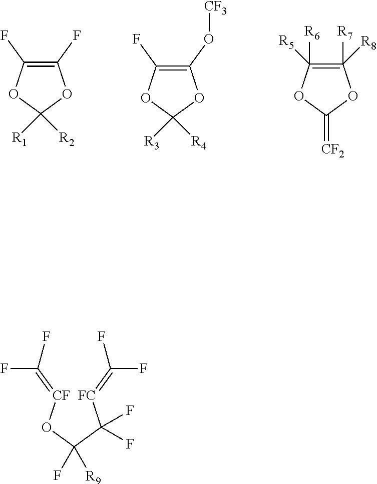

wherein
R₁ and R₂ are independently F, CF₃, CF₂CF₃, CF₂H, CF₂CF₂H, CFHCF₃, CFHCF₂H;
R₃ and R₄ are independently F, CF₃, or CF₂CF₃, CF₂H, CF₂CF₂H, CFHCF₃, CFHCF₂H;
R₅, R₆, R₇, and R₈ are independently F, CF₃, or CF₂CF₃, CF₂H, CF₂CF₂H, CFHCF₃, CFHCF₂H and R₆ and R₇ can be contained within a 5- or 6-membered ring; and
R₉ is F, CF₃, or CF₂CF₃.

Aspect 6. The copolymer of aspect 5, wherein the fluorinated ring monomer is a single compound.

Aspect 7. The copolymer of aspect 5, wherein the fluorinated ring monomer is two or more different compounds.

Aspect 8. The copolymer of aspect 1, wherein the fluorinated ring monomer is:

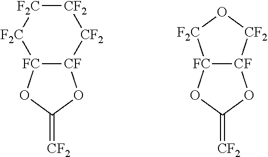

or a combination thereof.

Aspect 9. The copolymer of aspects 1-8, wherein the fluorinated ring monomer is in the amount of 80 mol % to 99 mol %.

Aspect 10. The copolymer of aspects 1-9, wherein the comonomer is perfluorinated.

Aspect 11. The copolymer of aspects 1-10, wherein the comonomer is an olefinic compound.

Aspect 12. The copolymer of aspects 1-10, wherein the comonomer comprises one or more compounds having the following structure:

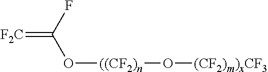

wherein n and m are independently 1, 2, or 3, and x is 1 or 2.

Aspect 13. The copolymer of aspects 1-12, wherein the comonomer is a single compound.

Aspect 14. The copolymer of aspects 1-12, wherein the comonomer is two or more different compounds.

Aspect 15. The copolymer of aspects 1-14, wherein the comonomer is:

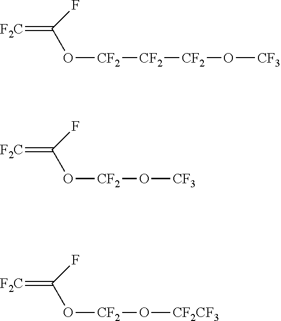

or any combination thereof.

Aspect 16. The copolymer of aspects 1-15, wherein the comonomer is in the amount of 1 mol % to 20 mol %.

Aspect 17. The copolymer of aspect 1, wherein the fluorinated ring monomer comprises one or more of the following compounds:

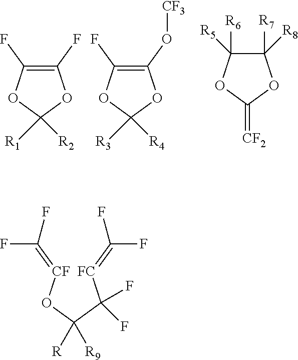

wherein
R₁ and R₂ are independently F, CF₃, CF₂CF₃, CF₂H, CF₂CF₂H, CFHCF₃, CFHCF₂H;
R₃ and R₄ are independently F, CF₃, or CF₂CF₃, CF₂H, CF₂CF₂H, CFHCF₃, CFHCF₂H;
R₅, R₆, R₇, and R₈ are independently F, CF₃, or CF₂CF₃, CF₂H, CF₂CF₂H, CFHCF₃, CFHCF₂H and R₆ and R₇ can be contained within a 5- or 6-membered ring; and
R₉ is F, CF₃, or CF₂CF₃, and
   the comonomer comprises one or more compounds having the following structure:

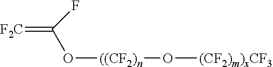

wherein n and m are independently 1, 2, or 3, and x is 1 or 2.

Aspect 18. The copolymer of aspect 17, wherein the comonomer is in the amount of 1 mol % to 20 mol %.

Aspect 19. The copolymer of aspect 1, wherein the fluorinated ring monomer is:

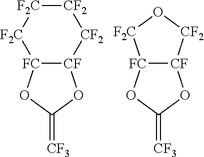

or a combination thereof, and
the comonomer is:

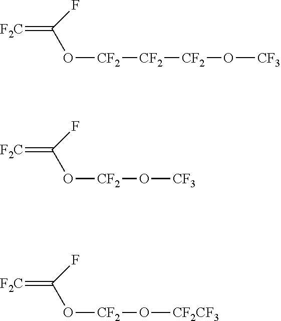

or any combination thereof.

Aspect 20. The copolymer of aspect 19, wherein the comonomer is in the amount of 1 mol % to 20 mol %.

Aspect 21. The copolymer of aspects 1-20, wherein the copolymer is produced by solution or aqueous emulsion polymerization.

Aspect 22. The copolymer of aspects 1-21, wherein the polymerization is conducted in the presence of an initiator.

Aspect 23. The copolymer of aspect 22, wherein the initiator comprises a hydrocarbon peroxide, a fluorocarbon peroxide, a hydrocarbon peroxydicarbonate, an inorganic fluorocarbon initiator, or any combination thereof.

Aspect 24. An amorphous copolymer comprising (a) a plurality of fluorinated ring units in the amount of 1 mol % to 99.5 mol %, wherein the fluorinated ring unit is at least a five membered ring and (b) a comonomeric unit in the amount of from 0.5 mol % to 99 mol %, wherein the comonomeric unit is fluorinated and has two or more ether oxygens.

Aspect 25. The copolymer of aspect 24, wherein the fluorinated ring unit is perfluorinated.

Aspect 26. The copolymer of aspects 24-25, wherein the fluorinated ring unit comprises a five or six membered ring.

Aspect 27. The copolymer of aspects 24, wherein the fluorinated ring unit comprises one or more of the following structures:

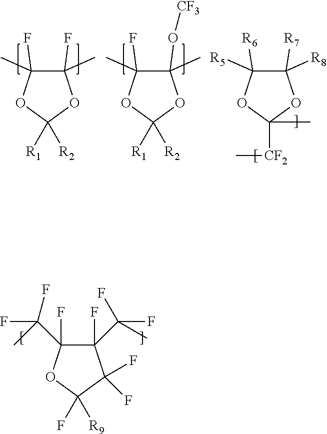

wherein
R₁ and R₂ are independently F, CF₃, CF₂CF₃, CF₂H, CF₂CF₂H, CFHCF₃, CFHCF₂H;
R₃ and R₄ are independently F, CF₃, or CF₂CF₃, CF₂H, CF₂CF₂H, CFHCF₃, CFHCF₂H;
R₅, R₆, R₇, and R₈ are independently F, CF₃, or CF₂CF₃, CF₂H, CF₂CF₂H, CFHCF₃, CFHCF₂H and R₆ and R₇ can be contained within a 5- or 6-membered ring; and
R₉ is F, CF₃, or CF₂CF₃.

Aspect 28. The copolymer of aspects 24-27, wherein the fluorinated ring unit is a single structural unit.

Aspect 29. The copolymer of aspects 24-27, wherein the fluorinated ring unit is two or more different structural units.

Aspect 30. The copolymer of aspects 24-29, wherein the fluorinated ring unit is:

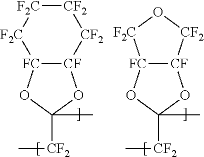

or a combination thereof.

Aspect 31. The copolymer of aspects 24-30, wherein the fluorinated ring unit in the amount of 80 mol % to 99 mol %.

Aspect 32. The copolymer of aspects 24-31, wherein the comonomeric unit is perfluorinated.

Aspect 33. The copolymer of aspects 24-32, wherein the comonomeric unit comprises one or more units having the following structure:

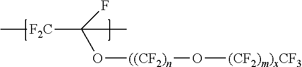

wherein n and m are independently 1, 2, or 3, and x is 1 or 2.

Aspect 34. The copolymer of aspect 33, wherein the comonomeric unit is a single structural unit.

Aspect 35. The copolymer of aspect 33, wherein the comonomeric unit is two or more different structural units.

Aspect 36. The copolymer of aspects 24-35, wherein the comonomeric unit is:

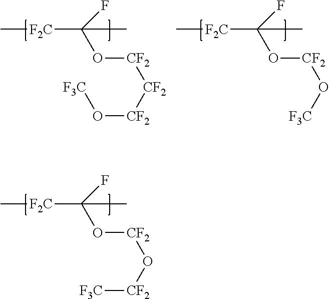

or any combination thereof.

Aspect 37. The copolymer of aspects 24-36, wherein the comonomeric unit is in the amount of 1 mol % to 20 mol %.

Aspect 38. The copolymer of aspect 24, wherein the fluorinated ring unit comprises one or more of the following structures:

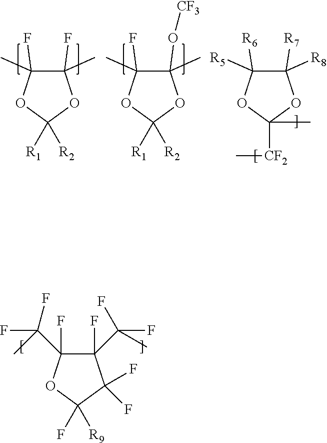

wherein
R₁ and R₂ are independently F, CF₃, CF₂CF₃, CF₂H, CF₂CF₂H, CFHCF₃, CFHCF₂H;
R₃ and R₄ are independently F, CF₃, or CF₂CF₃, CF₂H, CF₂CF₂H, CFHCF₃, CFHCF₂H;
R₅, R₆, R₇, and R₈ are independently F, CF₃, or CF₂CF₃, CF₂H, CF₂CF₂H, CFHCF₃, CFHCF₂H and R₆ and R₇ can be contained within a 5- or 6-membered ring; and
R₉ is F, CF₃, or CF₂CF₃; and
   the comonomeric unit comprises one or more units having the following structure:

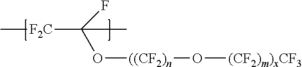

wherein n and m are independently 1, 2, or 3, and x is 1 or 2.

Aspect 39. The copolymer of aspect 38, wherein the comonomeric unit is in the amount of 1 mol % to 20 mol %.

Aspect 40. The copolymer of aspect 24, wherein the fluorinated ring unit is:

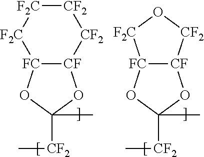

or a combination thereof, and

the comonomeric unit is:

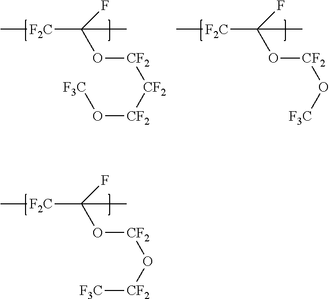

or any combination thereof.

Aspect 41. The copolymer of aspect 40, wherein the comonomeric unit is in the amount of 1 mol % to 20 mol %.

Aspect 42. The copolymer is any one of aspects 1-41, wherein the copolymer has a glass transition temperature of from 0° C. to 300° C.

Aspect 43. The copolymer is any one of claims 1-41, wherein the copolymer has a Mₙ of from 10 kDa to 2,000 kDa.

Aspect 44. The copolymer is any one of aspects 1-41, wherein the copolymer has a M_{w} of from 10,000 g/mol to 3,000,000 g/mol.

Aspect 45. An article comprising the copolymer in any of one of aspects 1-41.

Aspect 46. The article of aspect 45, wherein the article comprises a multi-layer structured article, wherein at least one layer of the structure comprises the copolymer.

Aspect 47. The article of aspect 45, wherein the article comprises a film, membrane, tube, or fiber.

Aspect 48. The article of aspect 45, wherein the article comprises a layer or coating of the copolymer, wherein the layer or coating has a thickness of less than or equal to 1 μm.

Aspect 49. A method for separating a first gaseous component from a gaseous mixture said process comprising passing the gaseous mixture across a separation membrane comprising the copolymer in any of one of aspects 1-41.

Aspect 50. The method of aspect 49, wherein the method comprises
(a) passing the gaseous mixture across a separation membrane having a feed side and a permeate side, the separation membrane having a selective layer that is selectively permeable to at least the first gaseous component, said selective layer comprising the copolymer;
(b) providing a driving force sufficient to provide for transmembrane permeation of at least a portion of the gaseous mixture from the feed side to the permeate side of the separation membrane, resulting in a gaseous permeate stream on the permeate side of the separation membrane and a gaseous retentate stream on the feed side of the separation membrane, wherein the gaseous permeate stream comprises the first gaseous component.

Aspect 51. The method of aspect 50, wherein the permeate stream has a concentration of first component that is greater than a concentration of the first component in the retentate stream.

Aspect 52. The method of aspects 50-51, further comprising withdrawing the permeate stream from the permeate side of the separation membrane.

Aspect 53. The method of aspects 50-52, further comprising withdrawing the retentate stream from the feed side of the separation membrane.

Aspect 54. The method of aspects 49-53, wherein the first gaseous component is carbon dioxide, hydrogen sulfide, helium, or any combination thereof.

Aspect 55. The method of aspects 49-53, wherein the gaseous mixture comprises methane and carbon dioxide.

Aspect 56. The method of aspects 49-55, wherein more than about 50% or more than about 60% or more than about 70% or more than about 80% or more than about 90% or more than about 95% of the first gaseous component in the gaseous mixture permeates through the separation membrane.

Aspect 57. A separation membrane comprising a feed side and a permeate side, the separation membrane having a selective layer comprising the copolymer in any of one of aspects 1-41.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### Example 1: Synthesis of PBVE-co-PFMPVE Copolymer

### Reaction Condition I

An exemplary polymeric material comprising PBVE-co-PFMPVE copolymer was prepared according to the following reaction scheme:

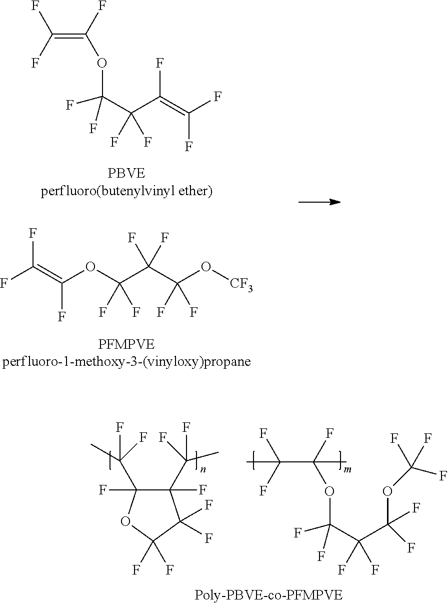

To a 1 L stainless steel reactor was added a magnetic stir bar and perfluorooctane (300 mL) solvent. The lid was attached and valves to an argon source and vacuum (30 Torr) were connected. The solvent was degassed by cycling four times through vacuum/argon backfill. PBVE (40 mL, 64 g) was next added via syringe with a 12-inch stainless steel needle, along with PFMPVE (3.0 mL, 4.6 g). The reactor was placed in an oil bath set to 50° C. and initiated using hexafluoropropylene oxide dimer peroxide (HFPO-DP, CF₃CF₂CF₂OCF(CF₃)COO]₂) solution (0.16 M in Vertrel XF. 0.5 mL precharge, 1.5 mL added over 8 hrs. by syringe pump). After 72 hours the solution was transferred to a 500 mL round bottom flask and reduced in vacuo at 50° C. and 30 Torr to afford 14.7 g of soft colorless polymer that was still wet with solvent. Several grams of this wet material were further dried in open air in an aluminum pan at 280° C. for 24 h. This dry material was submitted for T_{g} determination by DSC, molecular weight by GPC, and comonomer ratio by ¹⁹F NMR spectroscopy.

Results: T_{g}=86.7° C. (PBVE homopolymer=108° C.). Material was amorphous due to lack of observable melting endotherm. Mₙ=176,000 g/mol, M_{w}=303,900 g/mol. % PFMPVE by ¹⁹F NMR=5.0 mol %.

### Reaction Condition II

To a 25 mL glass vial was added PBVE (15.0 mL, 24.0 g) and PFMPVE (0.8 mL, 1.3 g) and a magnetic stir bar. Also added was 40 mg of perfluorobenzoyl peroxide initiator (made as detailed in Oldham, P. H.; Williams, G. H. J. Chem. Soc. (C), 1970, 1260). The cap was tightened and the vial was placed in an oil bath at 80° C. for 24 h. Residual monomer was removed from the resulting colorless glassy solid by heating it to 200° C. at 300 milliTorr for 8 hrs to give 23.0 g of a colorless amorphous polymer.

Results: T_{g}=95.8° C. (PBVE homopolymer=108° C.), Mₙ 227,000 g/mol. Material was amorphous due to lack of observable melting endotherm. % PFMPVE by ¹⁹F NMR=4.6 mol %.

### Reaction Condition III

The polymerization from Reaction Condition II was repeated, but with the following monomer amounts: PBVE: 10.0 mL, 16.0 g; PFMPVE: 2.0 mL, 3.2 g.

Results: 18.8 g of colorless polymer was obtained. T_{g}=74.5° C., Mₙ 196,000 g/mol. Material was amorphous due to lack of observable melting endotherm. % PFMPVE by ¹⁹F NMR=15.0 mol %.

### Reaction Condition IV

The polymerization from Reaction Condition II was repeated, but with the following monomer amounts: PBVE: 10.0 mL, 16.0 g; PFMPVE: 0.3 mL, 0.5 g.

Results: 15.3 g of colorless polymer was obtained. T_{g}=99.7° C., Mₙ 290,000 g/mol. Material was amorphous due to lack of observable melting endotherm. % PFMPVE by ¹⁹F NMR=3.5 mol %.

### Example 2: PDD-co-PFMPVE

### Reaction Condition V

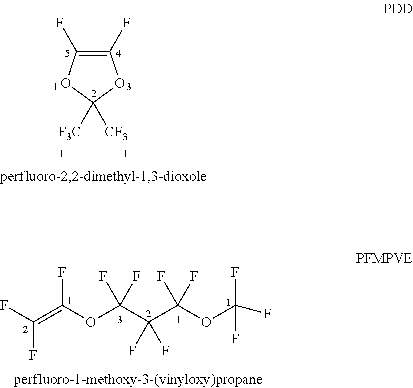 [SMILES: FC1=C(F)OC(C(F)(F)F)(C(F)(F)F)O1 ; FC(F)=C(F)OC(F)(F)C(F)(F)C(F)(F)OC(F)(F)F]

To a 250 mL Duran® glass bottle was added a magnetic stir bar and perfluorooctane (150 mL) solvent. The lid was attached and valves to an argon source and vacuum (30 Torr) were connected. The solvent was degassed by cycling four times through vacuum/argon backfill. Freshly distilled PDD (10 mL, 17.2 g) was next added via syringe with a 12-inch stainless steel needle, along with PFMPVE (23.0 mL, 34.5 g). The polymerization was initiated by the addition of hexafluoropropylene oxide dimer peroxide (HFPO-DP, CF₃CF₂CF₂OCF(CF₃)COO]₂) solution (0.16 M in Vertrel® XF. 2.0 mL) and allowed to stir at ambient temperature (22° C.) for 48 hrs. The solution was transferred to a 500 mL round bottom flask and reduced in vacuo at 50° C. and 30 Torr to afford 22.0 g of colorless polymer. This dry material was submitted for T_{g} determination by DSC, molecular weight by GPC, and comonomer ratio by ¹⁹F NMR spectroscopy.

Results: T_{g}=119.3° C. (PDD homopolymer=>340° C.). Material was amorphous due to lack of observable melting endotherm. Mₙ=105,000 g/mol. % PFMPVE by ¹⁹F NMR=30.0 mol %.

### Reaction Condition VI

The polymerization from Reaction Condition V was repeated, but with the following monomer amounts: PDD: 20.0 mL, 34.4 g; PFMPVE: 23.0 mL, 34.5 g. 29 g of colorless polymer was obtained.

Results: T_{g}=191.0° C. (PDD homopolymer=>340° C.). Material was amorphous due to lack of observable melting endotherm. Mₙ=277,000 g/mol. % PFMPVE by ¹⁹F NMR=19.6 mol %.

### Example 3: Fabrication of Membrane with PBVE-Co-PFMPVE Copolymer

A 100-micron-thick, 10 cm diameter circular film of high-permeability amorphous fluoropolymer was created using the following steps: 1) 3.5 g of the dried polymer from Example 1, Reaction Condition II was placed in the center between two 15.2 cm×15.2 cm×125 micron sheets of Kapton® film. Eight 100-micron stainless steel shims were taped in place around the perimeter between the Kapton® sheets to set the thickness of the polymer film. 2) This assembled sandwich was placed between two 15.2 cm×15.2 cm×6.4 mm mirror-polished stainless-steel plates to give rigidity to the assembly. 3) The assembly was placed between the heated platens (200° C.) of a hydraulic Carver press and allowed to come up to temperature with minimal contact pressure between the platens. After 5 minutes, the pressure was increased to ˜1,500 PSI. The heater elements were turned off and the assembly was allowed to cool to room temperature while under pressure. 4) The assembly was taken apart and the resulting film was trimmed to give a fluoropolymer disc of 10 cm diameter.

### Example 4: Carbon Dioxide Separations from Using the Amorphous Fluoropolymer Membrane

Membrane samples from Example 3 were tested for permeability of several different gases, including O₂, N₂, He, and CO₂. A feed stream of each gas was introduced to a feed side of the membrane at ambient temperature (20-25° C.) and at a feed pressure of 20-60 psig. The permeate side of the membrane was held at near atmospheric permeate pressure. The feed stream, permeate stream, and retentate stream were analyzed to calculate permeability. In these measurements, N₂, was used as a non-explosive proxy for CH₄, since the ratio of the permeabilities of these gases is typically relatively constant among the perfluorinated polymers. Hence it is expected that the materials showing improved CO₂/N₂ selectivity will also show improved CO₂/CH₄ selectivity. For each gas pair, the selectivity was approximated as the ratio of the pure-gas permeability of each monomer. With mixed-gas streams, the observed selectivity will typically be somewhat different than the ratio of pure-gas permeabilities, although this difference is usually relatively small in the case of perfluorinated polymers.

The measured permeabilities and associated selectivities are shown in Table 1, where the results from the membrane in Example 3 are compared with literature values for Asahi Glass CYTOP® polymer, which is a homopolymer of PBVE. Since the membrane in example 3 is a copolymer composed primarily of PBVE, with 4.6 mol % PFMPVE as a comonomer, this comparison indicates that the addition of PFMPVE monomer to the copolymer composition is extremely effective in improving the CO₂/N₂ selectivity of the polymer.

TABLE 1

| | Permeability (barrer) | | | | Selectivity | | |
|---|---|---|---|---|---|---|---|
| | O₂ | N₂ | He | CO₂ | O₂/N₂ | He/N₂ | CO₂/N₂ |
| Membrane from | 8.2 | 2.8 | 81 | 41 | 2.9 | 28 | 14 |
| Example 3 | | | | | | | |
| CYTOP | n/a | 18 | 790 | 150 | n/a | 43 | 8.3 |
| Literature Value | | | | | | | |

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

1. An amorphous copolymer produced by polymerizing (a) one or more fluorinated ring monomers in the amount of 1 mol % to 99.5 mol %, wherein the fluorinated ring monomer is at least a five membered ring and (b) a comonomer in the amount of from 0.5 mol % to 99 mol %, wherein the comonomer comprises a fluorinated compound with two or more ether oxygens.

2. The copolymer of claim 1, wherein the fluorinated ring monomer is perfluorinated.

3. The copolymer of claim 1, wherein the fluorinated ring monomer is an olefinic compound.

4. The copolymer of claim 1, wherein the fluorinated ring monomer comprises a five or six membered ring.

5. The copolymer of claim 1, wherein the fluorinated ring monomer comprises one or more of the following compounds: 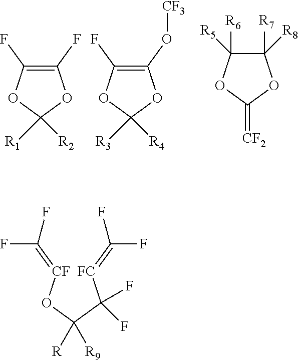
wherein
R₁ and R₂ are independently F, CF₃, CF₂CF₃, CF₂H, CF₂CF₂H, CFHCF₃, CFHCF₂H;
R₃ and R₄ are independently F, CF₃, or CF₂CF₃, CF₂H, CF₂CF₂H, CFHCF₃, CFHCF₂H;
R₅, R₆, R₇, and R₈ are independently F, CF₃, or CF₂CF₃, CF₂H, CF₂CF₂H, CFHCF₃, CFHCF₂H and R₆ and R₇ can be contained within a 5- or 6-membered ring; and
R₉ is F, CF₃, or CF₂CF₃.

6. The copolymer of claim 5, wherein the fluorinated ring monomer is a single compound.

7. The copolymer of claim 5, wherein the fluorinated ring monomer is two or more different compounds.

8. The copolymer of claim 1, wherein the fluorinated ring monomer is: 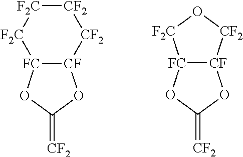
or a combination thereof.

9. The copolymer of claim 1, wherein the fluorinated ring monomer is in the amount of 80 mol % to 99 mol %.

10. The copolymer of claim 1, wherein the comonomer is perfluorinated.

11. The copolymer of claim 1, wherein the comonomer is an olefinic compound.

12. The copolymer of claim 1, wherein the comonomer comprises one or more compounds having the following structure: 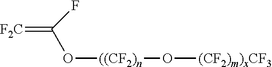
wherein n and m are independently 1, 2, or 3, and x is 1 or 2.

13. The copolymer of claim 12, wherein the comonomer is a single compound.

14. The copolymer of claim 12, wherein the comonomer is two or more different compounds.

15. The copolymer of claim 1, wherein the comonomer is: 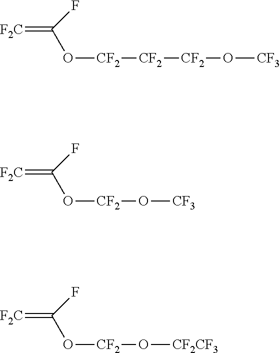
or any combination thereof.

16. The copolymer of claim 1, wherein the comonomer is in the amount of 1 mol % to 20 mol %.

17. The copolymer of claim 1, wherein the fluorinated ring monomer comprises one or more of the following compounds: 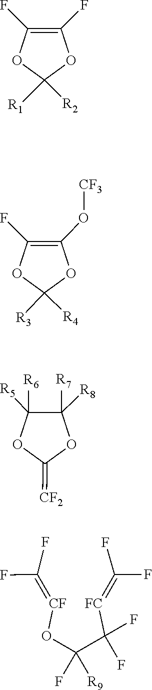
wherein
R₁ and R₂ are independently F, CF₃, CF₂CF₃, CF₂H, CF₂CF₂H, CFHCF₃, CFHCF₂H;
R₃ and R₄ are independently F, CF₃, or CF₂CF₃, CF₂H, CF₂CF₂H, CFHCF₃, CFHCF₂H;
R₅, R₆, R₇, and R₈ are independently F, CF₃, or CF₂CF₃, CF₂H, CF₂CF₂H, CFHCF₃, CFHCF₂H and R₆ and R₇ can be contained within a 5- or 6-membered ring; and
R₉ is F, CF₃, or CF₂CF₃; and
the comonomer comprises one or more compounds having the following structure: 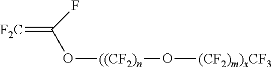
wherein n and m are independently 1, 2, or 3, and x is 1 or 2.

18. The copolymer of claim 17, wherein the comonomer is in the amount of 1 mol % to 20 mol %.

19. The copolymer of claim 1, wherein the fluorinated ring monomer is: 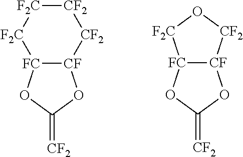
or a combination thereof, and
the comonomer is: 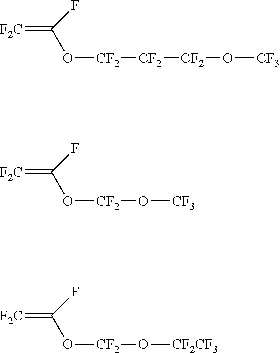
or any combination thereof.

20. The copolymer of claim 19, wherein the comonomer is in the amount of 1 mol % to 20 mol %.

21. The copolymer of claim 1, wherein the copolymer is produced by solution or aqueous emulsion polymerization.

22. The copolymer of claim 1, wherein the polymerization is conducted in the presence of an initiator.

23. The copolymer of claim 22, wherein the initiator comprises a hydrocarbon peroxide, a fluorocarbon peroxide, a hydrocarbon peroxydicarbonate, an inorganic fluorocarbon initiator, or any combination thereof.

24. An amorphous copolymer comprising (a) a plurality of fluorinated ring units in the amount of 1 mol % to 99.5 mol %, wherein the fluorinated ring unit is at least a five membered ring and (b) a comonomeric unit in the amount of from 0.5 mol % to 99 mol %, wherein the comonomeric unit is fluorinated and has two or more ether oxygens.

25. The copolymer of claim 24, wherein the fluorinated ring unit is perfluorinated.

26. The copolymer of claim 24, wherein the fluorinated ring unit comprises a five or six membered ring.

27. The copolymer of claim 24, wherein the fluorinated ring unit comprises one or more of the following structures: 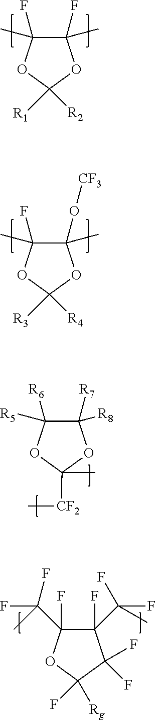
wherein
R₁ and R₂ are independently F, CF₃, CF₂CF₃, CF₂H, CF₂CF₂H, CFHCF₃, CFHCF₂H;
R₃ and R₄ are independently F, CF₃, or CF₂CF₃, CF₂H, CF₂CF₂H, CFHCF₃, CFHCF₂H;
R₅, R₆, R₇, and R₈ are independently F, CF₃, or CF₂CF₃, CF₂H, CF₂CF₂H, CFHCF₃, CFHCF₂H and R₆ and R₇ can be contained within a 5- or 6-membered ring; and
R₉ is F, CF₃, or CF₂CF₃.

28. The copolymer of claim 27, wherein the fluorinated ring unit is a single structural unit.

29. The copolymer of claim 27, wherein the fluorinated ring unit is two or more different structural units.

30. The copolymer of claim 24, wherein the fluorinated ring unit is: 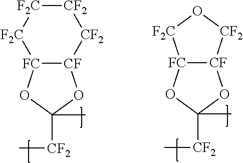
or a combination thereof.

31. The copolymer of claim 24, wherein the fluorinated ring unit in the amount of 80 mol % to 99 mol %.

32. The copolymer of claim 24, wherein the comonomeric unit is perfluorinated.

33. The copolymer of claim 24, wherein the comonomeric unit comprises one or more units having the following structure: 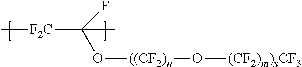
wherein n and m are independently 1, 2, or 3, and x is 1 or 2.

34. The copolymer of claim 33, wherein the comonomeric unit is a single structural unit.

35. The copolymer of claim 33, wherein the comonomeric unit is two or more different structural units.

36. The copolymer of claim 24, wherein the comonomeric unit is: 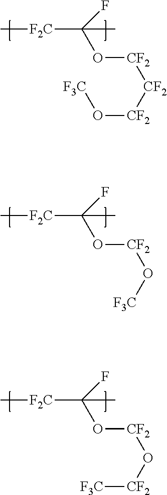
or any combination thereof.

37. The copolymer of claim 24, wherein the comonomeric unit is in the amount of 1 mol % to 20 mol %.

38. The copolymer of claim 24, wherein the fluorinated ring unit comprises one or more of the following structures: 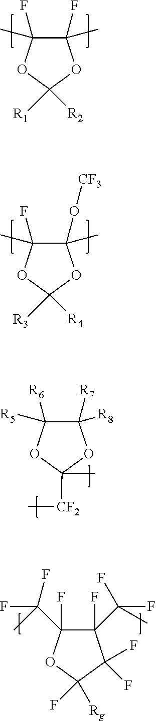
wherein
R₁ and R₂ are independently F, CF₃, CF₂CF₃, CF₂H, CF₂CF₂H, CFHCF₃, CFHCF₂H;
R₃ and R₄ are independently F, CF₃, or CF₂CF₃, CF₂H, CF₂CF₂H, CFHCF₃, CFHCF₂H;
R₅, R₆, R₇, and R₈ are independently F, CF₃, or CF₂CF₃, CF₂H, CF₂CF₂H, CFHCF₃, CFHCF₂H and R₆ and R₇ can be contained within a 5- or 6-membered ring; and
R₉ is F, CF₃, or CF₂CF₃; and
the comonomeric unit comprises one or more units having the following structure: 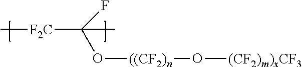
wherein n and m are independently 1, 2, or 3, and x is 1 or 2.

39. The copolymer of claim 38, wherein the comonomeric unit is in the amount of 1 mol % to 20 mol %.

40. The copolymer of claim 24, wherein the fluorinated ring unit is: 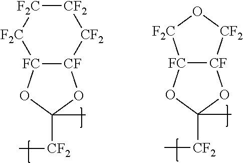
or a combination thereof, and
the comonomeric unit is: 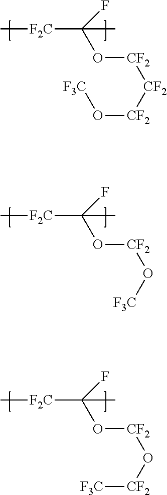
or any combination thereof.

41. The copolymer of claim 40, wherein the comonomeric unit is in the amount of 1 mol % to 20 mol %.

42. The copolymer of claim 1, wherein the copolymer has a glass transition temperature of from 0° C. to 300° C.

43. The copolymer of claim 1, wherein the copolymer has a Mₙ of from 10 kDa to 2,000 kDa.

44. The copolymer of claim 1, wherein the copolymer has a M_{w} of from 10,000 g/mol to 3,000,000 g/mol.

45. An article comprising the copolymer of claim 1.

46. The article of claim 45, wherein the article comprises a multi-layer structured article, wherein at least one layer of the structure comprises the copolymer.

47. The article of claim 45, wherein the article comprises a film, membrane, tube, or fiber.

48. The article of claim 45, wherein the article comprises a layer or coating of the copolymer, wherein the layer or coating has a thickness of less than or equal to 1 μm.

49. A method for separating a first gaseous component from a gaseous mixture said process comprising passing the gaseous mixture across a separation membrane comprising the copolymer of claim 1.

50. The method of claim 49, wherein the method comprises
(a) passing the gaseous mixture across a separation membrane having a feed side and a permeate side, the separation membrane having a selective layer that is selectively permeable to at least the first gaseous component, said selective layer comprising the copolymer;
(b) providing a driving force sufficient to provide for transmembrane permeation of at least a portion of the gaseous mixture from the feed side to the permeate side of the separation membrane, resulting in a gaseous permeate stream on the permeate side of the separation membrane and a gaseous retentate stream on the feed side of the separation membrane, wherein the gaseous permeate stream comprises the first gaseous component.

51. The method of claim 50, wherein the permeate stream has a concentration of first component that is greater than a concentration of the first component in the retentate stream.

52. The method of claim 50, further comprising withdrawing the permeate stream from the permeate side of the separation membrane.

53. The method of claim 50, further comprising withdrawing the retentate stream from the feed side of the separation membrane.

54. The method of claim 49, wherein the first gaseous component is carbon dioxide, hydrogen sulfide, helium, or any combination thereof.

55. The method of claim 49, wherein the gaseous mixture comprises methane and carbon dioxide.

56. The method of claim 49, wherein more than about 50% or more than about 60% or more than about 70% or more than about 80% or more than about 90% or more than about 95% of the first gaseous component in the gaseous mixture permeates through the separation membrane.

57. A separation membrane comprising a feed side and a permeate side, the separation membrane having a selective layer comprising the copolymer of claim 1.
